(19) United States
(12) Patent Application Publication
(10) Pub. No.: US 2020/0290462 A1
(43) Pub. Date: Sep. 17, 2020

(54) Mechanically Actuated Control-Arm Regenerative Output System (MACROS)

(71) Applicant: BOARD OF TRUSTEES OF THE UNIVERSITY OF ARKANSAS, Fayetteville, AR (US)

(72) Inventor: Nicholas Drake Broadbent, Darmstadt (DE)

(73) Assignee: BOARD OF TRUSTEES OF THE UNIVERSITY OF ARKANSAS, Fayetteville, AR (US)

(21) Appl. No.: 16/818,495

(22) Filed: Mar. 13, 2020

Related U.S. Application Data
(60) Provisional application No. 62/817,941, filed on Mar. 13, 2019.

(51) Int. Cl. B60L 7/02; H02P 3/14; B60L 50/61; B60K 6/387

(52) U.S. Cl. CPC B60L 7/02; H02P 3/14; H02P 9/48; B60K 6/387; B60L 50/61

(57) ABSTRACT

A multiple mechanically actuated regenerative output system having a rack gear that moves linearly between a first position and a second position to a shaft of an alternator.

### RELATED APPLICATIONS

This application claims priority to U.S. Provisional Application Ser. No. 62/817,941 filed on Mar. 13, 2019, which is incorporated herein by reference.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

10 years ago, the first Kinetic Energy Recovery System (KERS) was designed. It harnessed the kinetic energy of a slowing car to produce electrical energy (i.e. energy regeneration), whereas a non-KERS equipped car would expend that energy as heat during braking. It was used extensively in Formula 1 and has recently been implemented in some high-end production automobiles. Several attempts were also made at developing a KERS that utilized the kinetic energy of suspension rather than braking to regenerate electrical energy (hydraulically actuated, electromagnetically actuated, mechanically actuated), but most have been abandoned due to the cost of development and a lack of manufacturability resulting from complex design schemes.

### BRIEF SUMMARY OF THE INVENTION

In one embodiment, the present invention provides a mechanically actuated control-arm regenerative output system, or MACROS, that harnesses the kinetic energy from a suspension system that would otherwise be expended as heat to produce electrical energy via mechanical actuation. This electrical energy can be used to power applicable on-board systems.

Other embodiments of the present invention have applicability to the following industries either as an aftermarket installation (bolt-on; no modification) or manufacturer installation: automotive to increase the range of electric cars or increase fuel economy; agriculture equipment to improve fuel efficiency as well as to power auxiliary equipment; defense to increase the range of equipment as well as power auxiliary systems; space exploration to increase fuel efficiency and to power auxiliary systems; and over the road freight to increase fuel efficiency.

In other embodiments, the present invention provides a multiple mechanically actuated regenerative output system comprising a rack gear that moves linearly between a first position and a second position, and when the rack gear moves towards the first position a shaft of an alternator is rotated.

In other embodiments, the present invention provides a system for generating a current in a moving piece of equipment comprising a rack gear connected to a pinion gear; the pinion gear attached to a freewheeling hub; and the freewheeling hub is attached to a shaft of an alternator.

In other embodiments, the present invention provides a method for generating a current using the movement of a piece of equipment comprising steps of: attaching a rack gear connected to a portion of the piece of equipment that moves linearly causing the rack gear to move between a first position and a second position; when the rack gear moves towards the first position, a shaft of an alternator is rotated.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is a perspective view of a first embodiment of the present invention.

FIG. 2 is an exploded view of the embodiment shown in FIG. 1.

FIGS. 3A, 3B, 3C, 3D and 3E illustrate the operation of an embodiment of the present invention.

FIGS. 4A, 4B, 4C and 4D illustrate the operation of an alternate embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

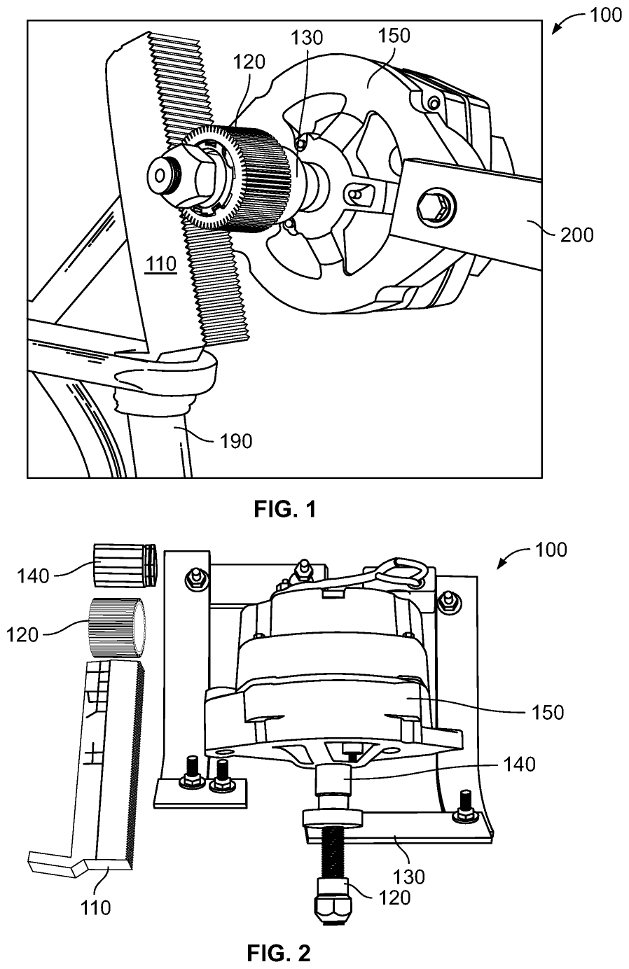

In one embodiment, as shown in FIGS. 1-2, mechanically actuated control-arm regenerative output system 100 includes rack gear 110 which is attached to moving part 190 which may be a strut. Pinion gear 120, ratchet gear 130, freehub 140 and Permanent Magnet Alternator (PMA) 150 are also provided and, in a preferred embodiment, these components are stationary.

In use, as a moving vehicle or piece of equipment encounters a surface deviation, such as a bump, a mechanical component of the suspension system, such as part 190, will move as the deviation is encountered. This, in turn, will cause at least one of the suspension components to move. This movement can be harnessed and converted into energy.

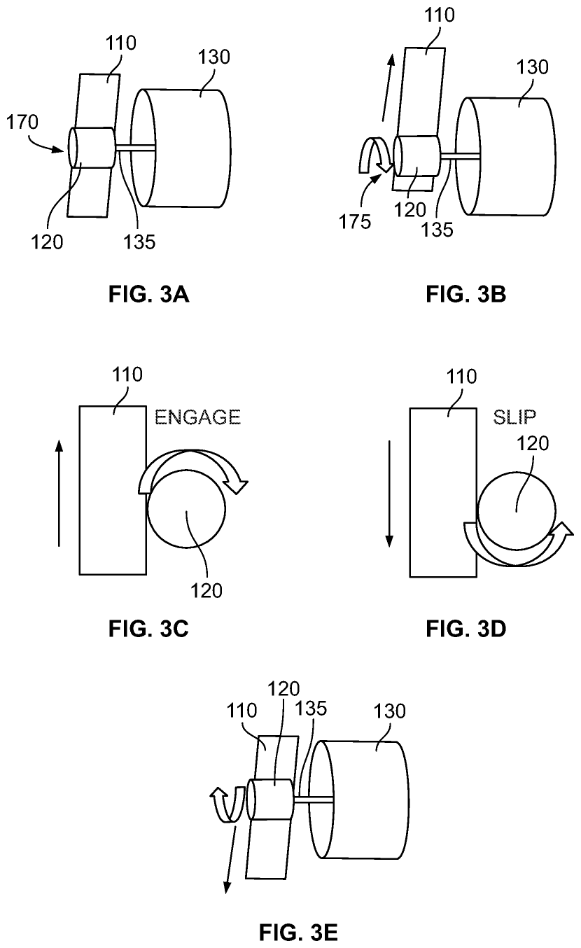

In one preferred embodiment, as shown in FIGS. 1 and 3A-3E, as a component moves, attached rack gear 110 is adapted to move from a first position 170 to a second position 175. As rack gear 110 moves toward the second position, it engages pinion gear 120 causing it to rotate. As pinion gear rotates 120, ratchet gear 130 is engaged. Since the ratchet gear is connected to the PMA shaft 135, the shaft is rotated thereby spinning a magnetic rotor that generates a voltage.

As shown in FIGS. 3d and 3E, once rack gear 110 reaches the second position 175 and travels back towards first position 170, it needs to do so without spinning the shaft in a direction opposite of the direction in which energy is created. To do this, ratchet gear 130 is adapted to slip allowing for the free spinning of the PMA shaft in a direction that generates a current.

In another embodiment, the pinion gear is adapted to move in a direction opposite the spinning of the shaft during energy generation when the rack gear returns to the first position. Thus, the ratchet gear is not engaged (i.e. it slips on the ratchet teeth) and therefore does not impede the motion of the alternator rotor shaft.

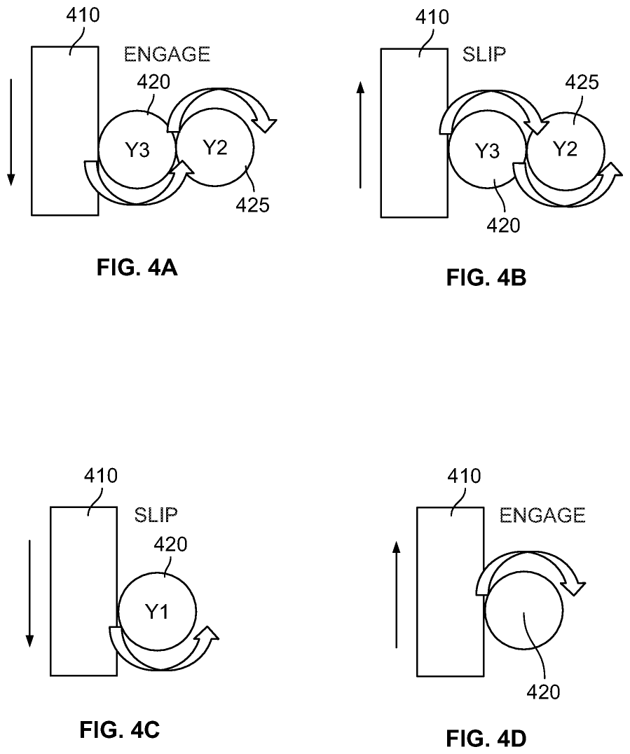

In yet another preferred embodiment involving a moving vehicle, but which could be used in any application, the present invention works as shown in FIGS. 4A-4D. As rack gear 410 moves linearly, the engagement between rack gear 410 and pinion gear 420, causes pinion gear 420 to rotate in a first direction. As further shown in FIG. 4A, the rotation of pinion gear 420 causes ratchet gear 425 to rotate and spin the shaft of the PMA. Once the linear direction of rack gear 410 reverses, it rotates pinion gear 420 in the opposite direction which, in turn, also rotates ratchet gear 425 in the opposite direction. However, ratchet gear is designed to slip and not rotate the PMA shaft when traveling in this direction.

Thus, when the alternator shaft spins, a magnetic rotor is spun inside a tightly wound stator coil thus producing an electromagnetic force (i.e. voltage). Because of gravity, what goes up must come down. Therefore, suspension displacement (and consequently, the displacement of your control-arm) is sinusoidal (alternates between positive and negative displacements).

While a ratcheting freewheeling system has been described above, the ratchet gear is one of many freewheeling or overrunning clutch assemblies known to those of skill in the art that may be used with the present invention. What is important, is that when the freewheeling hub changes direction, the shaft of the PMA is allowed to spin freely without interference in a direction that generates energy.

In yet other embodiments, multiple mechanically actuated control-arm regenerative output systems may be used with a single piece of equipment. This has particular application in agriculture and heavy equipment as well as motor vehicles.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A multiple mechanically actuated regenerative output system comprising: a rack gear that moves linearly between a first position and a second position; when said rack gear moves towards said first position a shaft of an alternator is rotated.

2. The system of claim 1 wherein said rack gear is connected to a freewheeling hub; and said freewheeling hub attached to a shaft of an alternator.

3. The system of claim 2 wherein when said rack gear moves towards said first position, said shaft of said alternator is rotated by said freewheeling hub.

4. The system of claim 3 wherein when said rack moves away from said second position towards said first position, said shaft of said alternator is not rotated by said freewheeling hub.

5. The system of claim 4 wherein said freewheeling hub is a ratchet gear.

6. The system of claim 4 wherein said freewheeling hub is a clutch.

7. A system for generating a current in a moving piece of equipment comprising: a rack gear connected to a pinion gear; said pinion gear attached to a freewheeling hub; and said freewheeling hub attached to a shaft of an alternator.

8. The system of claim 7 wherein said rack gear moves between a first position and a second position, and when said rack gear moves towards said first position, said shaft of said alternator is rotated by said freewheeling hub.

9. The system of claim 8 wherein when said rack moves away from said second position towards said first position, said shaft of said alternator is not rotated by said freewheeling hub.

10. The system of claim 9 wherein said freewheeling hub is a ratchet gear.

11. The system of claim 9 wherein said freewheeling hub is a clutch.

12. A method for generating a current using the movement of a piece of equipment comprising steps of: attaching a rack gear connected to a portion of the piece of equipment that moves linearly causing said rack gear to linearly move between a first position and a second position; when said rack gear moves towards said first position, a shaft of an alternator is rotated.

13. The method of claim number 12 wherein said rack gear is connected to a freewheeling hub; and when said rack gear moves linearly between a first position and a second position, said freewheeling hub is rotated.

14. The method of claim 13 wherein said freewheeling hub is attached to a shaft of an alternator.

15. The method of claim 14 wherein when said rack gear moves towards said first position, said shaft of said alternator is rotated by said freewheeling hub.

16. The method of claim 15 wherein as said rack moves away from said second position towards said first position, said shaft of said alternator is not rotated by said freewheeling hub.

17. The method of claim 16 wherein said freewheeling hub is a ratchet gear.

18. The method of claim 16 wherein said freewheeling hub is a clutch.

19. The method of claim number 12 wherein said rack gear is connected to a pinion gear; said pinion gear connected to a freewheeling hub; when said rack gear moves towards said first position, said shaft of said alternator is rotated by said freewheeling hub which is rotated by said pinion gear; and when said rack moves away from said second position towards said first position, said shaft of said alternator is not rotated by said freewheeling hub even though said pinion gear rotates said freewheeling hub.

20. The method of claim 19 wherein said freewheeling hub is a ratchet gear.
